(19) United States
(12) Patent Application Publication
(10) Pub. No.: US 2010/0027062 A1
(43) Pub. Date: Feb. 4, 2010

(54) INFORMATION PROCESSING APPARATUS, JOB PROCESSING METHOD, AND STORAGE MEDIUM

(75) Inventor: Keiichi Takashima, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/509,344

(22) Filed: Jul. 24, 2009

(30) Foreign Application Priority Data
Jul. 29, 2008 (JP) 2008-195241

(51) Int. Cl. G06F 15/00

(52) U.S. Cl. 358/1.15

(57) ABSTRACT

When a printer driver receives print data from an application, a layout filter lays out pages. After that, when an overlay filter determines that automatic overlay printing is set, the overlay filter reconfigures the document structure of the print data. Then, a render filter performs printing on the reconfigured print data.

### BACKGROUND OF THE INVENTION

1. Field of the Invention

The present invention relates to an information processing apparatus for outputting a job to a print control device having form registration and overlay printing capabilities.

2. Description of the Related Art

With the aim of increasing the print speed and reducing traffic in transfer from a host to a printer, a printer having form registration and overlay printing capabilities and a printer driver controlling such capabilities are developed.

Unfortunately, usability of the form registration and overlay printing capabilities is not good when the capabilities are used from a general-purpose application, such as word processor or spreadsheet software, so they are not fully utilized now.

For example, to execute overlay printing in a general-purpose application, the steps are needed of creating a template document, performing form registration printing, separately creating a document in which a template is removed, specifying the registered form, and performing overlay printing.

However, managing a document in which a template is removed is a troublesome task because its content is not easy to understand on a displayed screen of the application and it is necessary to store it in association with the template.

To address this trouble, a necessary item is added to a template to create an integral document, and the document is normally printed in many cases. Alternatively, a document is often created by duplicating and changing an existing document without the creation of a specific template. Accordingly, form registration and overlay printing are less frequently used.

Japanese Patent Laid-Open No. 10-244727 describes, when an instruction to create a form is output together with a drawing instruction, an extraction of an instruction for an attribute previously specified as a component of the form from the drawing instruction and a transfer of the extracted instruction as form registration data to a printing device.

The above-mentioned patent document also describes, when an overlay printing instruction is output together with a drawing instruction, an extraction of an instruction for an attribute previously specified as a main body from the drawing instruction and a transfer of the extracted instruction as print data to a printing device.

That is, the above-mentioned patent document opens to the public the technique of facilitating a user to register a form or perform overlay printing.

However, with the technique disclosed in the above-mentioned patent document, it is necessary to create a document such that the form and the main body have different attributes. To this end, the power of expression for the document is limited. In addition, there is a problem in which a user must always keep in mind the attributes of the form and the main body.

Moreover, the user needs to specify either one of form registration and overlay printing, and this also presents a problem of complicating user's operation.

### SUMMARY OF THE INVENTION

The present invention provides a mechanism for enabling the creation of a form registration job and an overlay printing job with respect to document information output from an application in response to a simple operation instruction.

An information processing apparatus according to exemplary embodiments of the present invention has a configuration described below.

The information processing apparatus for outputting, to a printing device, document information comprising a plurality of pages output from an application includes an instruction unit configured to provide an instruction to perform overlay printing using a form created from the document information, a reconfiguration unit configured to, in response to the instruction to perform overlay printing provided by the instruction unit, compare objects contained in the document information and reconfigure the document information to a common drawing portion common to a plurality of pages and a difference drawing portion in which the common drawing portion common to the plurality of pages is removed from the document information, and a job creation unit configured to create a form registration job based on the common drawing portion obtained by the reconfiguration unit and an overlay job based on the difference drawing portion obtained by the reconfiguration unit.

Further features of the present invention will become apparent from the following description of exemplary embodiments (with reference to the attached drawings).

### BRIEF DESCRIPTION OF THE DRAWINGS

FIG. 1 is a block diagram of a print control system in which an information processing apparatus and a printing device can communicate with each other according to an embodiment of the present invention.

FIG. 2 illustrates one example of a configuration for printing performed in a host computer shown in FIG. 1.

FIG. 3 is an illustration for use in describing an outline of printing performed in a print system according to an embodiment of the present invention.

FIG. 4 is a flowchart that illustrates one example of a data processing process performed in an information processing apparatus according to an embodiment of the present invention.

FIG. 5 illustrates one example of a screen used for overlay settings provided by a printer driver shown in Fig. 3.

FIG. 6 is a flowchart that illustrates one example of a data processing process performed in an information processing apparatus according to an embodiment of the present invention.

FIG. 7 illustrates an example state of print data being processed in an information processing apparatus according to an embodiment of the present invention.

FIG. 8 illustrates an example state of print data being processed in an information processing apparatus according to an embodiment of the present invention.

FIG. 9 illustrates an example state of print data being processed in an information processing apparatus according to an embodiment of the present invention.

FIG. 10 illustrates an example state of print data being processed in an information processing apparatus according to an embodiment of the present invention.

FIG. 11 is a flowchart that illustrates one example of a data processing process performed in an information processing apparatus according to an embodiment of the present invention.

FIG. 12 illustrates how objects are processed in an information processing apparatus according to an embodiment of the present invention.

FIG. 13 is a flowchart that illustrates one example of a data processing process performed in an information processing apparatus according to an embodiment of the present invention.

FIG. 14 is a flowchart that illustrates one example of a data processing process performed in an information processing apparatus according to an embodiment of the present invention.

FIG. 15 is a flowchart that illustrates one example of a data processing process performed in an information processing apparatus according to an embodiment of the present invention.

FIG. 16 illustrates an example structure of print data being processed in an information processing apparatus according to an embodiment of the present invention.

FIG. 17 illustrates an example structure of print data being processed in an information processing apparatus according to an embodiment of the present invention.

FIG. 18 illustrates an example structure of print data being processed in an information processing apparatus according to an embodiment of the present invention.

FIG. 19 is a flowchart that illustrates one example of a data processing process performed in an information processing apparatus according to an embodiment of the present invention.

FIG. 20 is a flowchart that illustrates one example of a data processing process performed in an information processing apparatus according to an embodiment of the present invention.

FIG. 21 illustrates an example structure of print data being processed in an information processing apparatus according to an embodiment of the present invention.

FIG. 22 is a flowchart that illustrates one example of a data processing process performed in an information processing apparatus according to an embodiment of the present invention.

FIG. 23 illustrates an example memory map of a storage medium that stores various data processing programs readable by an information processing apparatus according to an embodiment of the present invention.

### DESCRIPTION OF THE EMBODIMENTS

Embodiments of the present invention are described below with reference to the drawings.

### Description of System Configuration

### First Embodiment

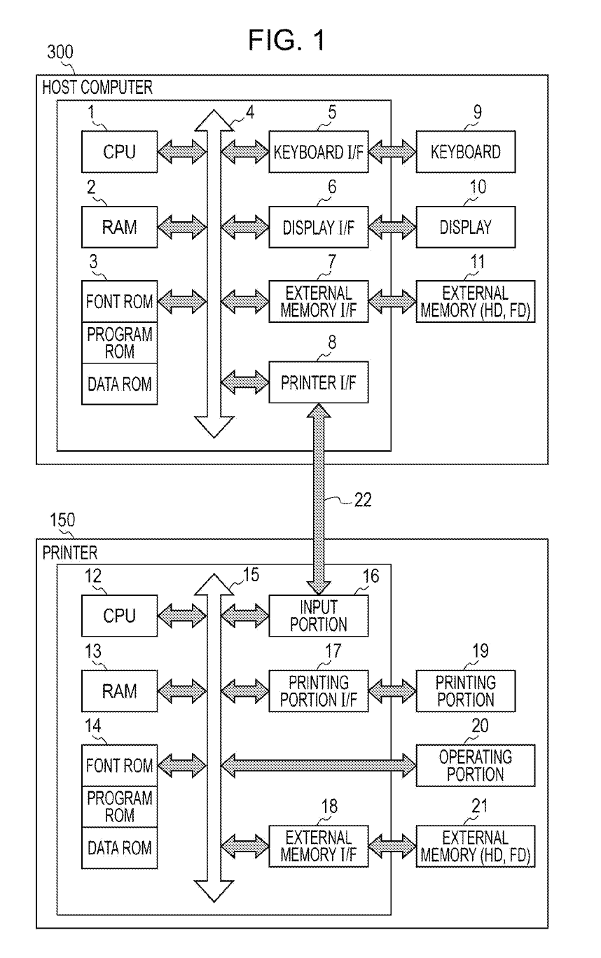

FIG. 1 is a block diagram that illustrates a configuration of a print control system in which an information processing apparatus and a printing device can communicate with each other according to a first embodiment of the present invention. The present embodiment uses, as an example, the XML Paper Specification (XPS) printing system, which is newly incorporated in Windows® Vista of Microsoft Corporation. In the following, an example of job processing of automatically creating a form registration job and an overlay job by a printer driver using the XPS printing system from document information output from a general-purpose application is described. In the present embodiment, the document information is XPS data.

It is noted that the present invention is applicable to any device configuration as long as the functions of the present invention are achieved unless otherwise specified. Examples of the configuration to which the present invention is applicable include a single device, a system composed of multiple devices, and a system performing processing over a network, such as a LAN or WAN.

Referring to FIG. 1, a host computer 300 includes a central processing unit (CPU) 1 executing document processing for a document that contains a figure, an image, text, a table (including a spreadsheet) on the basis of a document processing program stored in a program read-only memory (ROM) of a ROM 3 or an external memory 11.

The CPU 1 controls the devices connected to a system bus 4. The program ROM of the ROM 3 or the external memory 11 stores an operating system (hereinafter referred to as OS) being a control program of the CPU 1. In the present embodiment, Windows® Vista of Microsoft Corporation is used as one example of the OS, as described above.

A font ROM of the ROM 3 or the external memory 11 stores font data for use in the document processing. A data ROM of the ROM 3 or the external memory 11 stores various kinds of data for use in the document processing.

A random-access memory (RAM) 2 functions as a main memory and a work area of the CPU 1. A keyboard interface (I/F) 5 controls entry from a keyboard 9 or a pointing device (not shown).

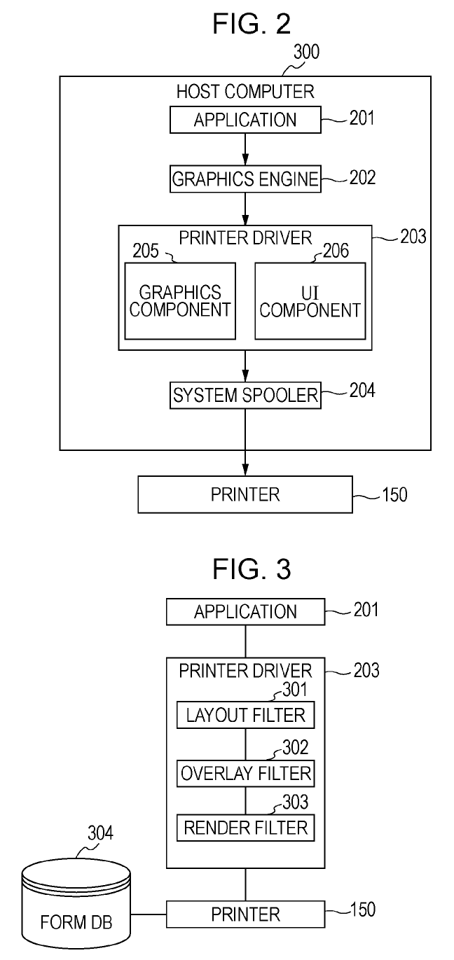

A display I/F 6 controls displaying of a display 10. An external memory I/F 7 controls access to the external memory 11 (e.g., a hard disk (HD) or a flexible disk (FD)). The external memory 11 stores a boot program, various applications, font data, a user file, an editing file, and a printer driver including a module illustrated below in FIG. 2.

A printer I/F 8 is connected to a printer 150 through a predetermined interactive interface 22 and controls communications with the printer 150.

The CPU 1 can expand outline fonts to a display information RAM set on the RAM 2 (rasterization), for example, and enables WYSIWYG on the display 10.

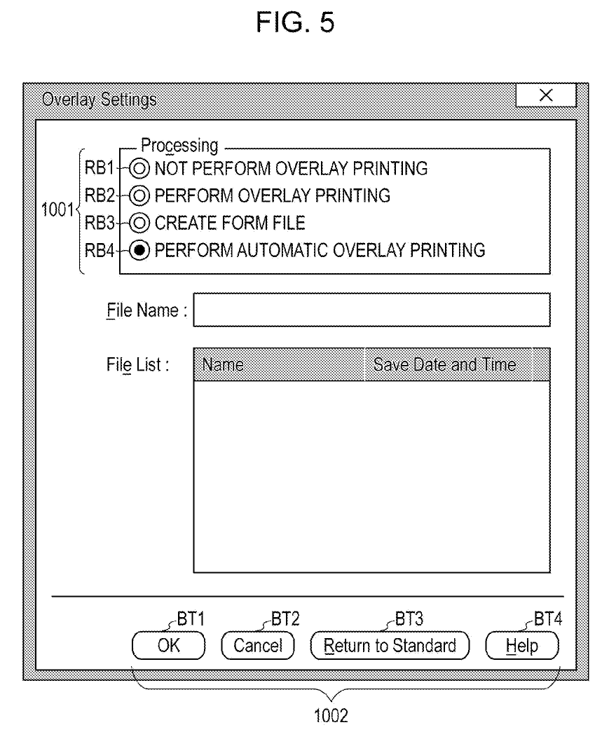

The CPU 1 opens various registered windows on the basis of a command specified by a mouse cursor (not shown) on the display 10 and executes various kinds of data processing. To print information created in an application, the user opens a user interface for allowing the user to specify the settings for the information on the display 10, specifies the settings for the printer 150, and selects the printing mode. At this time, the user can specify the settings for various print processing methods through a user interface provided by the printer driver. The user interface provided by the printer driver includes an overlay setting screen shown in FIG. 5.

In the printer 150, a CPU 12 is a printer CPU. The CPU 12 outputs an image signal as output information to a printing portion (printer engine) 19 through a printing portion I/F 17 connected to a system bus 15 on the basis of a control program stored in a program ROM of a ROM 14 or an external memory 21.

The program ROM of the ROM 14 stores a control program of the CPU 12. A font ROM of the ROM 14 stores font data for use in creating the output information.

If the printer 150 does not have the external memory 21 (e.g., hard disk), a data ROM of the ROM 14 stores information for use on the host computer.

The CPU 12 can interactively communicate with the host computer 300 through an input portion 16 and can inform the host computer 300 of the information in the printer 150. That information includes a status of the printer engine, information on network settings, the name of a device, and the name of a resource.

A RAM 13 functions as a main memory and a work area of the CPU 12 and is configured to be able to expand the amount of memory using an optional RAM connectable to an expansion port (not shown).

The RAM 13 can be used as an output information expanding region, an environmental data storage region, and nonvolatile RAM (NVRAM). Access to the above-described external memory 21 (e.g., a HD and an IC card) is controlled by an external memory I/F 18.

The external memory 21 is connected optionally and can store font data, an emulation program, and form data.

The external memory 21 can be composed of a plurality of external memories. That is, the number of the external memories 21 is at least one. In addition to a memory for a built-in font, other external memories, such as an optional font card and an external memory storing a program that can interpret a printer control language having a different language system can also be connected.

The printer 150 may also include an NVRAM (not shown) that can store information on the printer mode settings supplied from an operating portion 20. The RAM 13 or the external memory 21 can store form data transmitted from the host computer 300. In overlay printing, the printer 150 extracts form data specified in the print settings and overlays it in printing. The operating portion 20 has a switch and a light-emitting diode (LED) indicator for operations.

### Details of Printing in Host Computer 300

FIG. 2 illustrates one example of a configuration for printing performed in the host computer 300 shown in FIG. 1. In the present embodiment, various kinds of printing can be achieved by execution of the module described below by the CPU 1. In FIG. 2, the same reference numerals are used in the same elements as in FIG. 1.

Referring to FIG. 2, each of an application 201, a graphics engine 202, a printer driver 203, and a system spooler 204 exists as a file stored in the external memory 11.

Each of these elements is configured as a program module that is loaded into the RAM 2 by the OS or another module using a module of the OS and that is executed by the CPU 1.

Each of the application 201 and the printer driver 203 can be stored in the HD functioning as the external memory 11 through the FD of the external memory 11, a CD-ROM (not shown), or a network (not shown). The application 201 stored in the external memory 11 is loaded into the RAM 2 and executed by the CPU 1. Each of the application 201 and the printer driver 203 can also be downloaded from a server into the host computer 300 over a network and installed in the external memory 11.

In printing from the application 201 to the printer 150, output (drawing) is performed using the graphics engine 202 being in the executable state after being loaded into the RAM 2 in a similar way.

The graphics engine 202 loads the printer driver 203 prepared for the printer 150 from the external memory 11 into the RAM 2 and sets the printer driver 203 as the destination of an output of the application 201.

The graphics engine 202 receives print settings or print data from the application 201 and outputs the received settings or data to the printer driver 203 as print data.

A graphics component 205 of the printer driver 203 receives the print data from the graphics engine 202 and converts it into a control command that the printer can recognize, for example, page description language (PDL) data.

In such a way, the printer control command produced by the graphics component 205 is transmitted through the system spooler 204 loaded into the RAM 2 by the OS and is output to the printer 150 through the interface 22 (illustrated in FIG. 1).

A UI component 206 of the printer driver 203 receives the print settings from the graphics engine 202, displays and/or changes the print settings, and informs the application 201 through the graphics engine 202.

### XPS Data

In an XPS printing system newly incorporated in the OS, for example, Windows® Vista of Microsoft Corporation, the printer driver 203 receives XPS data as the print data. The XPS data has an XML-based data format, which can also be used as document information.

The document structure of the XML-based data format is a three-level tree structure of “Fixed Document Sequence” (hereinafter referred to as FDS), “Fixed Document” (hereinafter referred to as FD), and “Fixed Page” (hereinafter referred to as FP), which represent a job, a document, and a page, respectively.

The FP includes a plurality of drawing objects. In XPS data, the drawing objects have three categories: Path (figure), Glyphs (text), and Canvas (group).

Canvas is used as a parent object to logically combine a plurality of drawing objects or to refer to a resource described below.

Each of the drawing objects has a plurality of attributes corresponding to the type of drawing, and the plurality of attributes include an attribute relevant to the drawing and an attribute irrelevant to the drawing. The plurality of attributes also include a non-essential attribute. The reference to a resource, which is described below, is also achieved by an attribute.

The XPS data can have print settings called Print Ticket (hereinafter referred to as PT) therein.

Here, DEVMODE, which is one of the print settings for a GDI printing system, features setting all attributes at a time and switching the entire DEVMODE during the job if needed. In contrast, PT features the capability of specifying only a portion of the print settings in units of job/document/page.

Additionally, combining a plurality of drawing objects, defining the combined object as a single resource, and referring it from a Fixed Page or a Canvas enables commonality of the drawings. A plurality of resources can be defined in a resource dictionary. Other than drawing objects, a drawing brush can also be defined.

### Outline of Automatic Overlay Printing

FIG. 3 is an illustration for use in describing an outline of printing performed in the printing system according to the present embodiment. In FIG. 3, the same reference numerals are used in the same elements as in FIG. 2.

Referring to FIG. 3, when the application 201 executes printing a document having a plurality of pages created from the same template, the printer driver 203 receives print data having the XPS data format and outputs it to the printer 150. The printer driver 203 includes a layout filter (LF) 301, an overlay filter (OF) 302, and a render filter (RF) 303. The LF 301 functions as a unit for performing various kinds of layout and processes the print data, such as laying out pages and adding a stamp image.

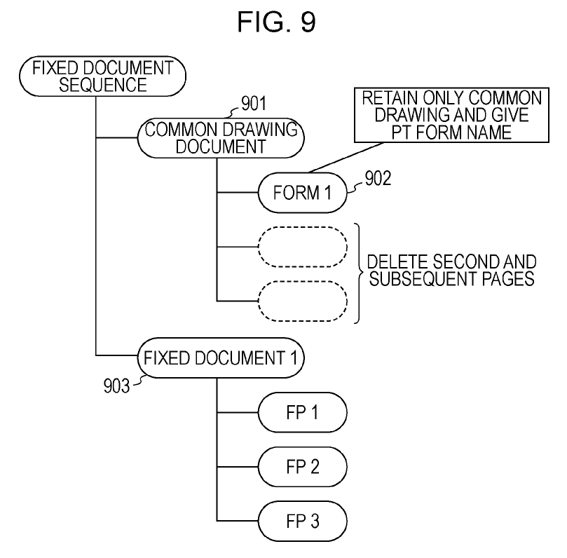

The OF 302 functions as a document-structure converting portion, reconfigures print data into XPS data composed of a common drawing FD and a difference drawing FD, and adds a form registration PT or an overlay printing PT. The OF 302 changes the document structure using a common drawing portion and a difference drawing portion in a way described below. Here, for the common drawing portion, to extract a common object from original print data, objects are compared in sequence from the lowest objects in pages 1 and 2 to search for a different object, and the found different object is deleted from page 1. For subsequent pages 3 to N, the same processing is performed. Accordingly, only a common drawing portion FP corresponding to the form illustrated in FIG. 9 can be extracted. After Form 1 is created, pages 2 to N are deleted. After that, the form name is set in the PT.

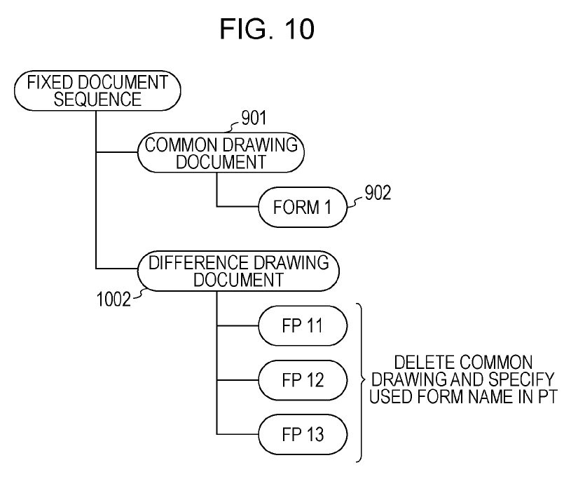

For the difference drawing portion, the common drawing portion FP is deleted from the original print data, and a difference drawing portion FD is created, as illustrated in FIG. 10.

The RF 303 functions as a printing portion, creates, from the XPS data to which PT is added, a form registration job, an overlay printing job, and a normal printing job receivable by the printer 150, and outputs it. A form database 304 stores form data received from the host computer 300. Here, the form database 304 can be in a region of the RAM 13 of the printer 150 or a region of the external memory 21.

### Details of Automatic Overlay Printing

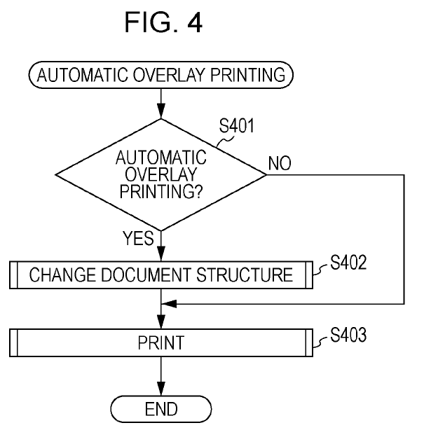

A process occurring when the printer driver 203 receives print data is described next with reference to FIGS. 4 to 9.

FIG. 4 is a flowchart that illustrates one example of a data processing process performed in the information processing apparatus according to the present embodiment. The present embodiment illustrates one example of print data processing performed by the host computer 300 illustrated in FIG. 1. Steps S401 to S403 are achieved by the CPU 1 illustrated in FIG. 1 loading the printer driver 203 into the RAM 2 and executing it.

When the printer driver 203 receives print data from the application 201, in step S401, the LF 301 lays out the pages and the OF 302 determines whether automatic overlay printing is set.

When the OF 302 determines that automatic overlay printing is set, in step S402, the OF 302 reconfigures the document structure of the print data into a common drawing portion and a difference drawing portion, as described below. In step S403, the RF 303 performs printing on the reconfigured print data. Then, the process is completed. In step S401, when the CPU 1 determines that automatic overlay printing is not set, flow proceeds to step S403.

FIG. 5 illustrates one example of a screen for overlay settings to be processed by the printer driver 203 illustrated in FIG. 3. This example screen is a printer-driver setting screen for use in specifying the settings for automatic overlay printing, and is displayed on the display 10 illustrated in FIG. 1 when a printing request is made by the application 201.

In FIG. 5, a processing radio button section 1001 includes four radio buttons RB1 to RB4 for use in selecting from among four different options for overlay printing. The radio button RB1 is selected when overlay printing is not to be performed.

The radio button RB2 is selected when overlay printing is to be performed. The radio button RB3 is selected when a form file is to be created. The radio button RB4 is selected when automatic overlay printing is to be performed.

A button section 1002 includes buttons BT1 to BT4 for use in controlling execution of the processing. The button BT1 functions as an OK button. The button BT2 functions as a cancel button. The button BT 3 functions as a button for returning the state to the standard. The button BT4 functions as a button for calling a help facility.

When the user selects “perform automatic overlay printing” on the radio button RB4 and clicks on the OK button BT1, in step S401 illustrated in FIG. 4, the OF 302 in the printer driver 203 illustrated in FIG. 3 determines that a request for automatic overlay printing is made.

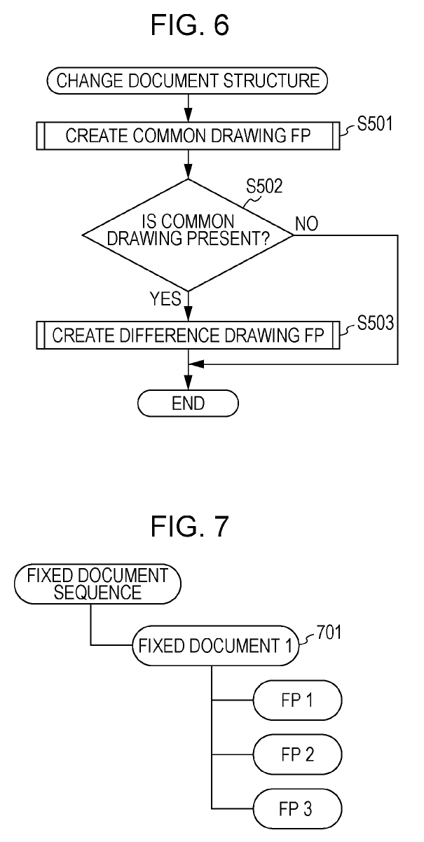

FIG. 6 is a flowchart that illustrates one example of a data processing process performed in the information processing apparatus according to the present embodiment. This example indicates an example detailed process for changing a document structure corresponding to step S402 illustrated in FIG. 4 by the OF 302 in the printer driver 203 illustrated in FIG. 3.

Steps S501 to S503 are achieved by the CPU 1 illustrated in FIG. 1 loading the OF 302 into the RAM 2 and executing it.

First, in step S501, the OF 302, which functions as a document-structure converting portion, extracts a common drawing portion from print data having an XPS data form received from the application 201 and creates a common drawing portion FP on the RAM 2. Then, in step S502, the OF 302 determines whether the common drawing portion FP is created on the RAM 2. When the OF 302 determines that the common drawing portion FP is created (YES in step S502), the OF 302 removes the common drawing portion FP from the original FD to create a difference drawing portion FD on the RAM 2 in step S503. Then, the process is completed. When the OF 302 determines that the common drawing portion FP is not created (NO in step S502), the process is completed.

FIGS. 7 to 10 illustrate an example of how print data is processed in the information processing apparatus according to the present embodiment. Example details of the process for changing a document structure in step S402 illustrated in FIG. 4 will now be described below.

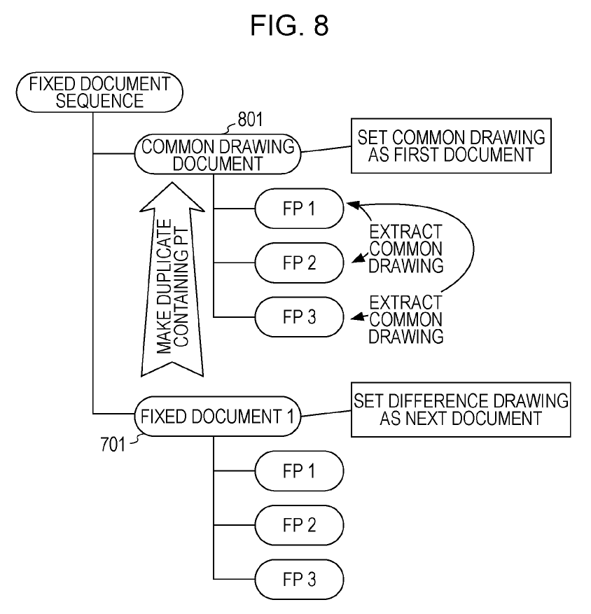

FIG. 7 corresponds to the XPS data structure of original print data. An original FD 701 includes three FPs consisting of FP 1 to FP 3. FIG. 8 illustrates an example in which an FDS includes a common drawing document and an FD. Here, the OF 302 copies the original FD 701 to use the duplicate as a common drawing FD 801, compares the three FPs of FP 1 to FP 3 in sequence, and extracts a common drawing portion FP to become a template (form 1 illustrated in FIG. 9) with respect to information on a document having a plurality of pages. The duplicate of the original FD 701 for use as the common drawing FD 801 made by the OF 302 contains the duplicate of the PT.

In FIG. 9, the OF 302 deletes FPs other than a common drawing portion FP 902 extracted as illustrated in FIG. 8 (in the example illustrated in FIG. 8, FP 2 and FP3). Then, the OF 302 adds a form registration PT that specifies the registration form name (form 1) to the common drawing portion FP 902 and crates a common drawing FD 901.

In FIG. 10, the OF 302 deletes the drawing of the common drawing portion FP from each of the FP 1 to FP 3 of an original FD 903 illustrated in FIG. 9, creates difference drawing portions FP 11 to FP 13, adds an overlay printing PT in which the form name of the used common drawing page is set as the form name to be used to each of the difference drawing portions FP 11 to FP 13, and creates a difference drawing FD 1002.

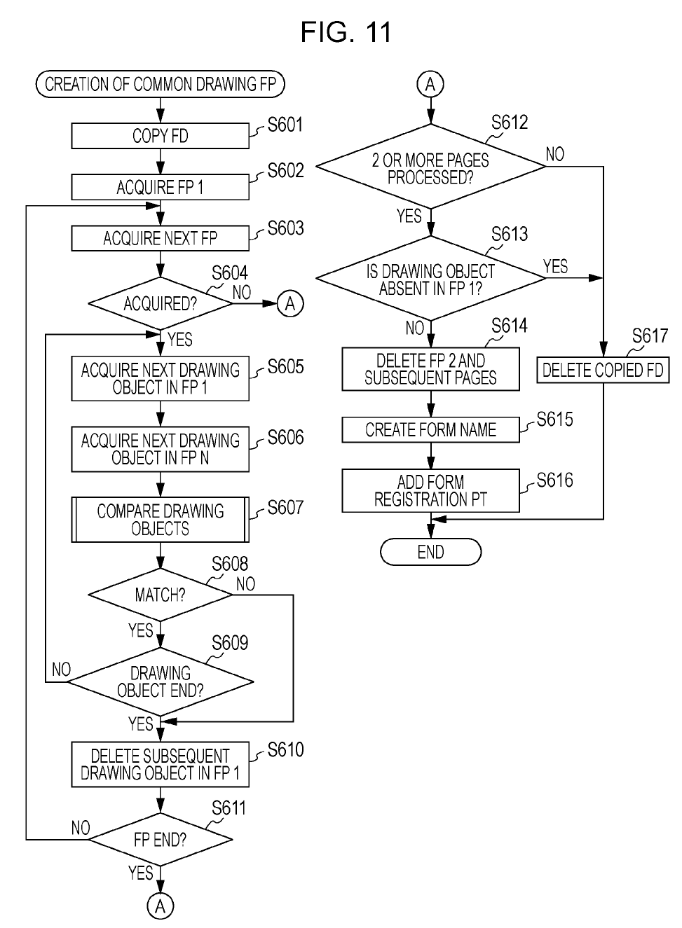

FIG. 11 is a flowchart that illustrates one example of a data processing process performed in the information processing apparatus according to the present embodiment. This example indicates a detailed example process for creating a common drawing FP in step S501 illustrated in FIG. 6 by the OF 302 illustrated in FIG. 3. Steps S601 to S617 are achieved by the CPU 1 illustrated in FIG. 1 loading the OF 302 into the RAM 2 and executing it.

First, in step S601, the OF 302, which functions as a document-structure converting portion, copies the original FD 701 on the RAM 2, as illustrated in FIG. 8, to create a model of the common drawing FD 801.

Typically, a printer cannot accurately superimpose print data on a form in printing unless the registered form exists at the time of processing an overlay printing job.

Accordingly, in printing corresponding to step S403 illustrated in FIG. 4, the common drawing FD 801 and difference drawing FD are located such that the common drawing FD 801 will be read prior to the difference drawing FD so as to enable the form registration job to be output prior to the overlay printing job.

Then, in step S602, the OF 302 acquires the FP 1 as the first target to be compared from the common drawing FD 801. In step S603, the OF 302 acquires the next FP. In step S604, the OF 302 determines whether the first FP 1 and the next FP are acquired. When the OF 302 determines that both the first FP 1 and the next FP are acquired (YES in step S604), the OF 302 acquires a drawing object to be processed next of each of the two FPs in steps S605 and S606. In step S607, the OF 302 performs comparison between the drawing objects. The details of the comparison will be described below.

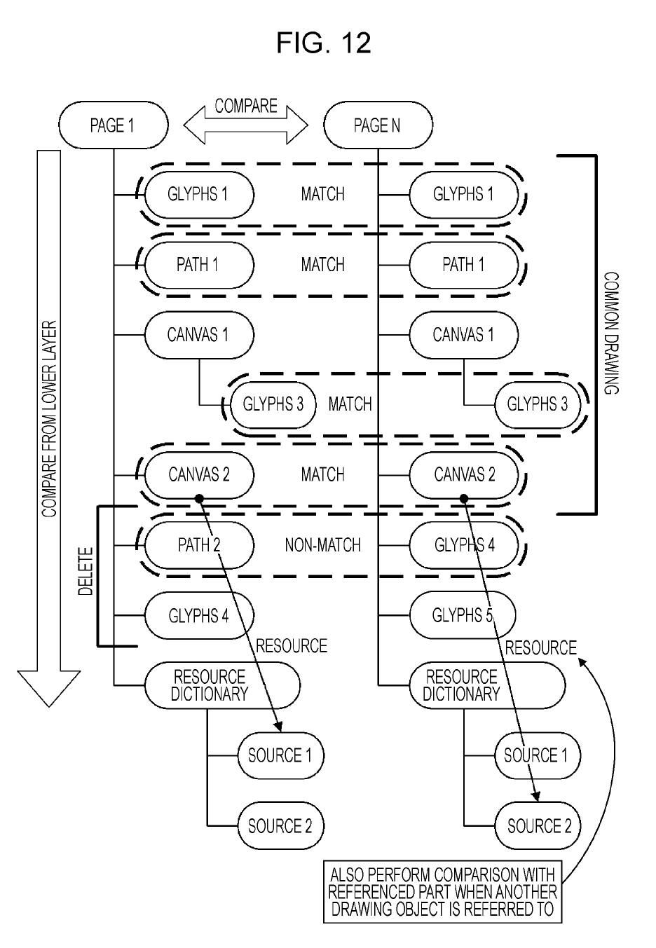

FIG. 12 illustrates how objects are processed in the information processing apparatus according to the present embodiment. An outline of the comparison between drawing objects is provided below.

In the example illustrated in FIG. 12, two FPs of page 1 and page N are targeted for comparison. The drawing objects are compared by the OF 302 in sequence from the lowest level. Here, when drawing objects refer to resources, the resources to which they refer are recursively compared.

In step S608, the OF 302 determines whether the drawing objects being targets for comparison match each other. When the OF 302 determines that the drawing objects being targets for comparison match each other (YES in step S608), in step S609, the OF 302 determines whether there is a drawing object to be compared next in each of the two FPs, that is, whether a drawing object to be compared ends. When the OF 302 determines that the drawing objects do not match each other (NO in step S608), flow proceeds to step S610.

When the OF 302 determines that a drawing object to be compared does not end (NO in step S609), steps S605 to S609 are repeated until a drawing object to be compared does not exist in at least one of the FPs.

When the OF 302 determines that the drawing objects being targets for comparison are different (NO in step S608) or when the OF 302 determines that a drawing object to be compared does not exist in at least one of the FPs (YES in step S609), flow proceeds to step S610. In step S610, the OF 302 deletes its subsequent drawing object in the FP 1 (see FIG. 12).

In step S611, the OF 302 determines whether there exists an FP to be compared next. When the OF 302 determines that there exists an FP to be compared next (NO in step S611), steps S603 to S611 are repeated until the FP 1 is compared with all the other FPs.

When the OF 302 determines that no FP to be compared next exists (YES in step S611), flow proceeds to step S612. In step S612, the OF 302 determines whether an FP having two or more pages is processed. When the OF 302 determines that an FP having two or more pages is processed (YES in step S612), in step S613, the OF 302 determines whether the FP 1 is empty of drawing objects.

When the OF 302 determines that the FP 1 is not empty of drawing objects (NO in step S613), which means a common drawing of a plurality of pages has been extracted, flow proceeds to step S614. In step S614, the OF 302 deletes pages other than the FP 1, i.e., the FP 2 and its subsequent pages. An example of this state is indicated by the broken lines under the common drawing document 901 illustrated in FIG. 9.

Then, in step S615, the OF 302 crates the form name (form 1) for use in registering a form in the printer. In step S616, the OF 302 adds the form registration PT that specifies the name (form 1) as the registration form name to the FP 1, and the process is completed.

When the registration form name created here is a unique name in a printer that receives an output of the computer, the form can be accurately specified in printing described below.

The form name can use a universally unique identifier (UUID) or a character string in which an IP address of a PC and a time at the time of printing are combined, for example, “xxx.xxx.xxx.xxx_hhmmss.”

When the OF 302 determines that only one page is processed (NO in step S612) or that the FP 1 is empty of drawing objects (YES in step S613), which means that no common drawing has been extracted, flow proceeds to step S617. In step S617, the OF 302 deletes the entire common drawing FD copied in step S601, and the process is completed.

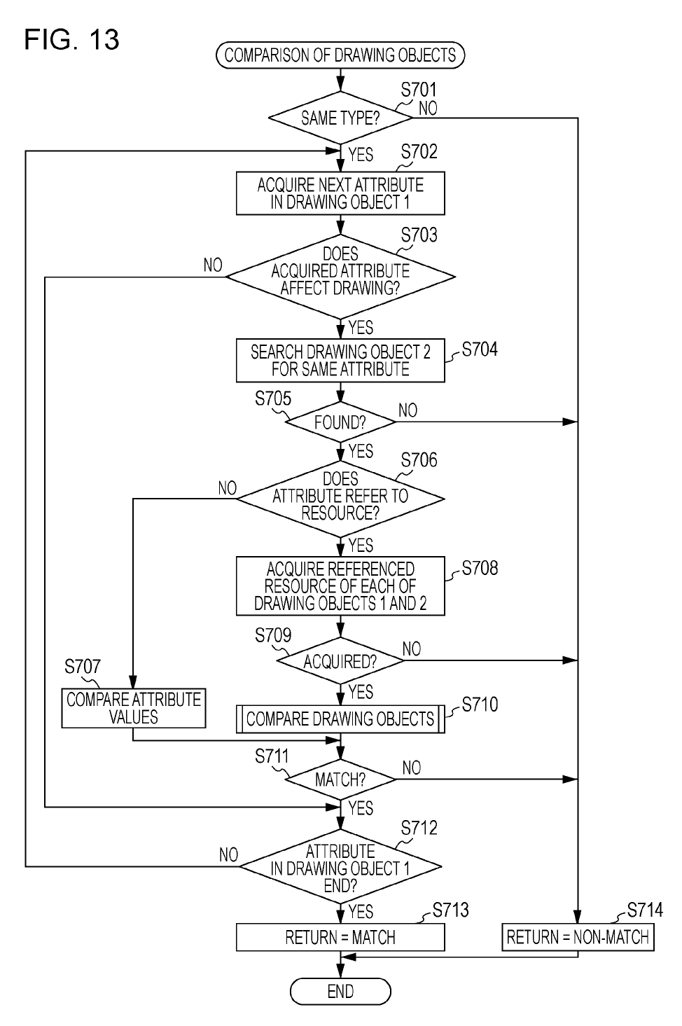

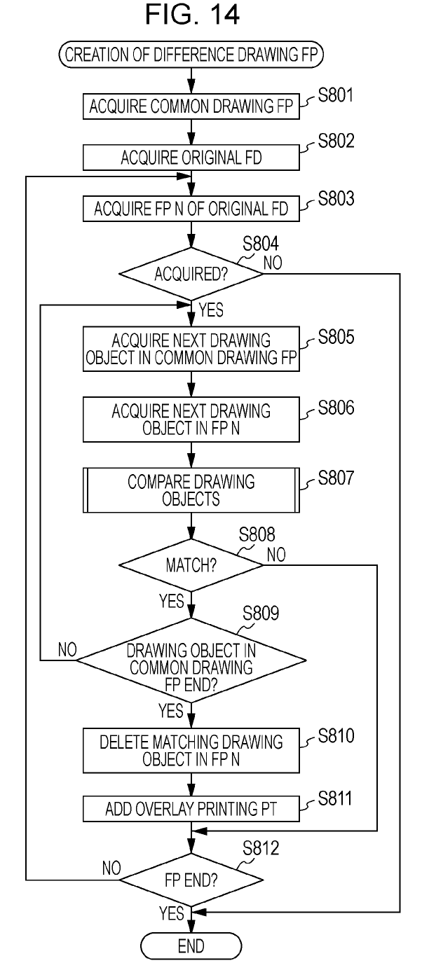

FIG. 13 is a flowchart that illustrates one example of a data processing process performed in the information processing apparatus according to the present embodiment. This example indicates an example process for comparing drawing objects in step S607 illustrated in FIG. 11 by the OF 302. Steps S701 to S714 are achieved by the CPU 1 illustrated in FIG. 1 loading the OF 302 into the RAM 2 and executing it. Here, a drawing object 1 of the FP 1 and a drawing object 2 of the FP N are compared. The drawing objects 1 and 2 are interchangeable.

First, in step S701, the OF 302 determines whether the drawing objects being targets for comparison are of the same type. When the OF 302 determines that the drawing objects being targets for comparison are of the same type (YES in step S701), in step S702, the OF 302 acquires an attribute to be processed next of the drawing object 1.

In step S703, the OF 302 determines whether the attribute acquired in step S702 is relevant to the drawing. When the OF 302 determines that the acquired attribute is irrelevant to the drawing (NO in step S703), flow moves to step S712. When the OF 302 determines that the acquired attribute is relevant to the drawing (YES in step S703), flow proceeds to step S704, where the OF 302 searches the drawing object 2 for the same attribute.

Then, in step S705, the OF 302 determines whether the same attribute is found. When the OF 302 determines that the same attribute is found (YES in step S705), in step S706, the OF 302 further determines whether that attribute refers to a resource. When the OF 302 determines that the attribute does not refer to a resource (NO in step S706), flow proceeds to step S707, where the OF 302 compares the attribute values themselves. Then, flow proceeds to step S711.

When the OF 302 determines that the attribute refers to a resource (YES in step S706), in step S708, the OF 302 acquires a referenced resource to which each of the drawing objects 1 and 2 refers. Then, in step S709, the OF 302 determines whether the referenced resource, to which each of the drawing objects 1 and 2 refers, is acquired. When the OF 302 determines that the referenced resource, to which each of the drawing objects 1 and 2 refers, is acquired (YES in step S709), in step S710, the drawing objects in the referenced resources are recursively compared.

Then, in step S711, the OF 302 determines whether the comparison in step S707 or the comparison in step S710 shows that there is a match. When the OF 302 determines that the comparison shows there is a match (YES in step S711), flow proceeds to step S712, where the OF 302 determines whether all of the attributes of the drawing object 1 has been compared.

When the OF 302 determines that there exists an attribute to be compared (NO in step S712), flow returns to step S702, and steps S702 to S712 are repeated until all of the attributes of the drawing object 1 has been compared.

In step S701, when the OF 302 determines that the drawing objects being targets for comparison are of different types (NO in step S701), in step S714, the OF 302 sets the return value at “non-match,” and the process is completed.

When the OF 302 determines that the same attribute is not found (NO in step S705), that the resource of the drawing object 1 or that of the drawing object 2 is not acquired (NO in step S709), or that there is not a match (NO in step S711), flow proceeds to step S714, and then the process is completed.

In step S712, when the OF 302 determines that there is not a non-matched attribute as a result of comparison for all attributes (that there is a match between the attributes), in step S713, the OF 302 sets the return value at “match,” and the process is completed.

FIG. 14 is a flowchart that illustrates one example of a data processing process performed in the information processing apparatus according to the present embodiment. This example indicates an example process for creating a difference drawing FP in step S503 illustrated in FIG. 6 by the OF 302. Steps S801 to S812 are achieved the CPU 1 illustrated in FIG. 1 loading the OF 302 into the RAM 2 and executing it. The process for creating a difference drawing FP is a process for deleting the drawing of the common drawing FP from each FP of the original FD to create a difference drawing FP, adding an overlay printing PT that specifies the form name to be used to each of the difference drawing FPs, and creating a difference drawing FD 1002, as illustrated in FIG. 10.

First, in step S801, the OF 302 acquires the common drawing FP created in step S501 as one of targets for comparison. Then, in step S802, the original FD is acquired, and in S803, and an FP to be processed next thereof is acquired as the other of targets for comparison.

In step S804, the OF 302 determines whether both of the original FD and the FP to be processed next are acquired.

When the OF 302 determines that both of the original FD and the FP to be processed next are not acquired (NO in step S804), the process is completed.

When the OF 302 determines that both of the original FD and the FP to be processed next are acquired (YES in step S804), in steps S805 and S806, a drawing object to be processed subsequent to the common drawing FP being one of the targets for comparison and that subsequent to the FP of the original FD are acquired. Then, in step S807, the OF 302 compares the drawing objects, as in the case of step S607 illustrated in FIG. 11.

In step S808, the OF 302 determines whether the drawing objects being the targets for comparison are the same. When the OF 302 determines that the drawing objects being the targets for comparison are the same (YES in step S808), in step S809, the OF 302 determines whether there exists a next drawing object to be compared in the two FPs. When the OF 302 determines that there exists a next difference drawing to be compared in the two FPs (NO in step S809), steps S805 to S809 are repeated until no difference drawing exists in the common drawing FP.

When, in step S809, the OF 302 determines that all of the drawing objects in the common drawing FP are the same, in step S810, the OF 302 deletes drawing objects in the FP being the target for comparison before there is not a match with the common drawing FP, and a difference drawing FP is accomplished.

In step S811, the OF 302 adds, to the difference drawing FP, the overlay printing PT that specifies the registration form name specified in the form registration PT added to the common drawing FP in step S616 illustrated in FIG. 11 as the form name to be used.

Then, in step S812, the OF 302 determines whether there exists an FP to be compared next in the original FD. When the OF 302 determines that there exists an FP to be compared next (NO in step S812), flow returns to step S803, and steps S803 to S812 are repeated until all FPs have been compared.

When the OF 302 determines that no FP to be compared next exists in the original FD (YES in step S812), the process is completed.

In step S808, when the OF 302 determines that the drawing object matches none of all the drawing objects in the common drawing FP (NO in step S808), the FP is considered as a normal FP that does not use the common drawing FP, and flow proceeds to step S812.

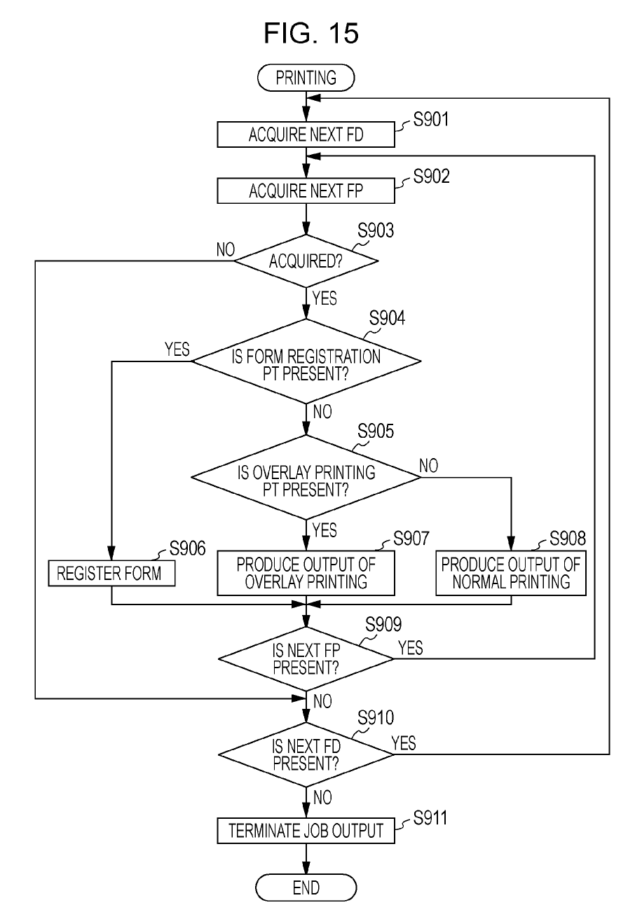

FIG. 15 is a flowchart that illustrates one example of a data processing process performed in the information processing apparatus according to the present embodiment. This example indicates an example printing process of step S403 illustrated in FIG. 4. Steps S901 to 911 are achieved by the CPU 1 illustrated in FIG. 1 loading the RF 303 into the RAM 2 and executing it. An example job creating process for creating a form registration job and an overlay printing job is described below.

The RF 303, which functions as a printing portion, receives print data reconfigured as a result of step S402 performed by the OF 302 and outputs a print job.

The reconfigured print data may contain any one of three types of FPs: a normal FP, a common drawing FP, and a difference drawing FP. The type of an FP is determined by the added PT. If a form registration PT is added, the type is determined as a common drawing FP; if an overlay printing PT is added, the type is determined as a difference drawing FP; and if neither is added, the type is determined as a normal FP.

The form registration PT and overlay printing PT are exclusively used, so there is no case where both of them are added.

First, in step S901, the RF 303 acquires an FD to be processed next. Then, in step S902, an FP to be processed next is acquired. In step S903, the RF 303 determines whether the FP is acquired. When the RF 303 determines that the FP is acquired (YES in step S903), in step S904, the RF 303 determines whether a form registration PT is added. When the RF 303 determines that no form registration PT is added (NO in step S904), in step S905, the RF 303 determines whether an overlay printing PT is added.

When the RF 303 determines that an overlay printing PT is added (YES in step S905), in step S907, the RF 303 outputs an overlay printing job, and then flow proceeds to step S909.

In step S905, when the RF 303 determines that no overlay printing PT is added (NO in step S905), flow proceeds to step S908, where the RF 303 outputs a normal print job, and then flow proceeds to step S909.

In step S909, the RF 303 determines whether there exists a next FP after either job is output. When the RF 303 determines that a next FP exists (YES in step S909), flow returns to step S902, and steps S902 to S909 are repeated.

In step S904, when the RF 303 determines that a form registration PT is added (YES in step S904), flow proceeds to step S906, where the RF 303 creates a form registration job by registering each form, and flow proceeds to step S909.

When the RF 303 determines that no next FP exists (NO in step S909), in step S910, the RF 303 determines whether a next FD exists. When the RF 303 determines that a next FD exists (YES in step S910), flow returns to step S901, and steps S901 to S910 are repeated.

When the RF 303 determines that all FDs are processed (NO in step S910), in step S911, the RF 303 performs job output ending processing, and the process is completed.

In the document-structure changing process in step S402 illustrated in FIG. 4, the common drawing FD is located before the difference drawing FD, so the form registration job is output before the overlay printing job. Accordingly, in printing, the printer 150 can accurately superimpose a form that is previously registered and print data that is received later.

In the present embodiment, print data having a document structure changed by the OF 302, which functions as a document-structure converting portion, is used in printing. However, it can also be used for purposes other than printing. For example, each of the drawing objects of a difference drawing FP can be used as an input source to a database of variable data.

With the present embodiment, the user simply selects automatic overly printing on a screen illustrated in FIG. 5. In response to the selection instruction, form registration and overlay printing of a document integrated with a template can be easily achieved from a general-purpose application.

Accordingly, the time required for printing a large number of pages of a document having a common format can be reduced, and traffic in transferring from a host to a printer can also be reduced.

With the present embodiment, there is no need to separate an instruction for form registration and that for overlay printing. Simply selecting processing only once enables an instruction for form registration and overlay printing to be made, and this can reduce the load on the user operation.

### Second Embodiment

The first embodiment discusses a case where a document having a plurality of pages created from the same template is subjected to automatic overlay printing. A second embodiment discusses a case where a single print job contains a plurality of documents each being a document that has a plurality of pages created from different templates.

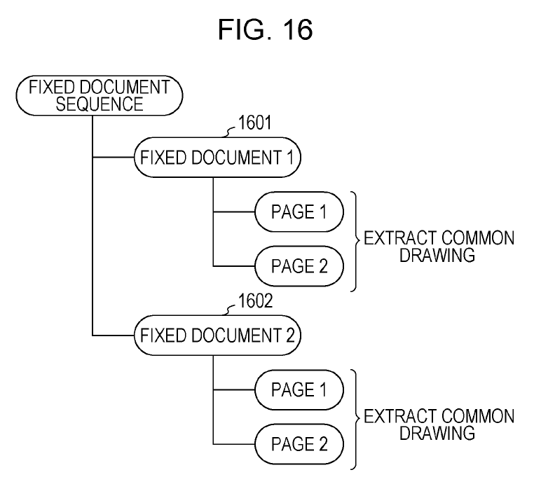

FIGS. 16 to 18 illustrate how print data is processed in the information processing apparatus according to the present embodiment.

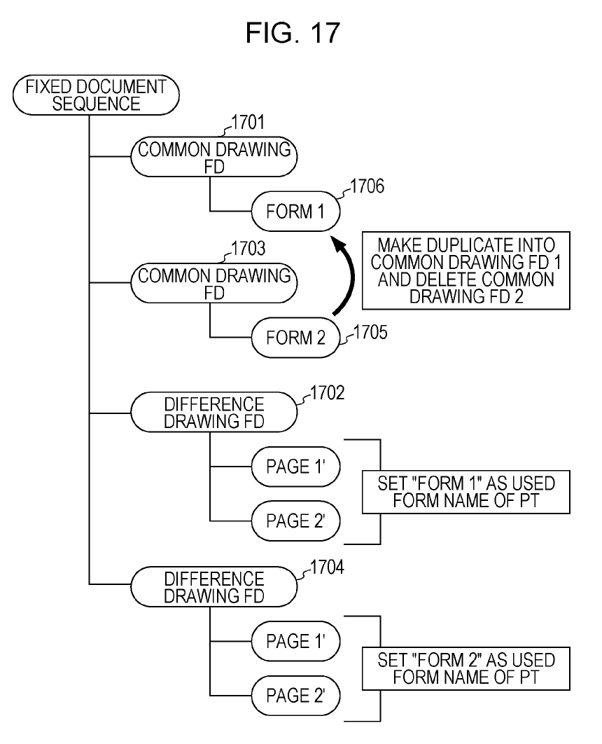

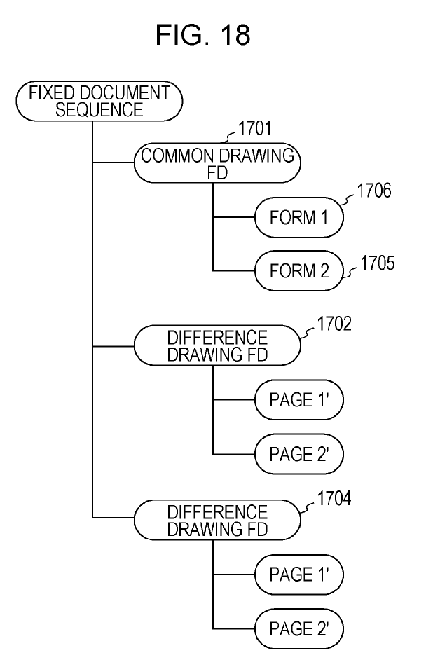

Original print data according to the present embodiment is defined as having an XPS data structure. As illustrated in FIG. 16, the original print data includes two FDs 1601 and 1602. FIG. 17 illustrates a state in which, after a common drawing FD 1701 and a difference drawing FD 1702 are created from the original FD 1601, a common drawing FD 1703 and a difference drawing FD 1704 are created from the original FD 1602. FIG. 18 illustrates a state in which an FP 1705 of the common drawing FD 1703 illustrated in FIG. 17 is copied to an FP 1706 of the common drawing FD 1701, and the common drawing FD 1703 is deleted.

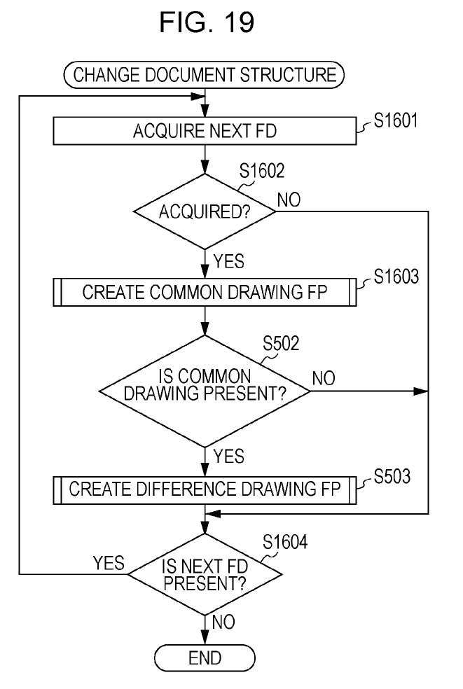

FIG. 19 is a flowchart that illustrates one example of a data processing process performed in the information processing apparatus according to the present embodiment. This example is an example process for changing a document structure illustrated in FIGS. 16 to 18. In FIG. 19, the same step numbers are used for similar steps to those in FIG. 6. Steps S1601 to S1604 and the other steps in FIG. 19 are achieved by the CPU 1 illustrated in FIG. 1 loading the OF 302 into the RAM 2 and executing it. The process is described in detail below.

First, in step S1601, the OF 302, which functions as a document-structure converting portion, acquires a first FD to be processed first from print data. In step S1602, the OF 302 determines whether the first FD is acquired from the print data. When the OF 302 determines that the first FD to be processed is acquired (YES in step S1602), in step S1603, the OF 302 extracts a common drawing and creates a common drawing FP.

The process for creating a common drawing FP in step S1603 is substantially the same as that illustrated in step S501 illustrated in FIG. 6, except that in step S1603 addition and changing are made to support a plurality of FDs. The details will be described below.

Then, in step S502, the OF 302 determines whether a common drawing FP is created as a result of the common drawing FP creation illustrated in step S1603. When the OF 302 determines that a common drawing FP is created (YES in step S502), in step S503, the common drawing is removed from the original FD, and a difference drawing FD is created.

When the creation in step S503 is completed, when the OF 302 determines that the common drawing is not acquired (NO in step S1602), or when the OF 302 determines that the common drawing FP is not created (NO in step S502), flow proceeds to step S1604.

In step S1604, the OF 302 determines whether there exists a next FD. When the OF 302 determines that there exists a next FD (YES in step S1604), flow returns to step S1601, and steps S1601 to S1604 are repeated until all FDs are processed. Then, the process is completed.

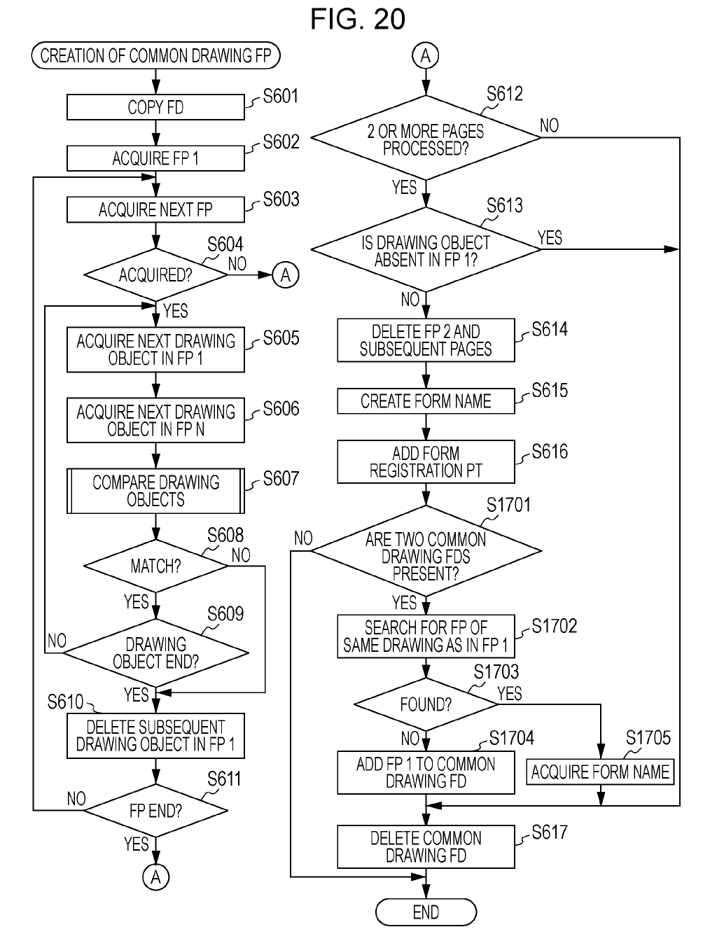

FIG. 20 is a flowchart that illustrates one example of a data processing process performed in the information processing apparatus according to the present embodiment. This example indicates an example detailed process for creating a common drawing FP in step S1603 illustrated in FIG. 19 by the OF 302. In FIG. 20, the same step numbers are used in similar steps to those in FIG. 11. Steps 1701 to S1705 and the other steps in FIG. 20 are achieved by the CPU 1 illustrated in FIG. 1 loading the OF 302 into the RAM 2 and executing it.

As described in the first embodiment, in copying an FD in step S601 illustrated in FIG. 11, typically, a printer cannot accurately superimpose print data on a form in printing unless the registered form exists at the time of processing an overlay printing job. Accordingly, in printing in step S403 illustrated in FIG. 4, the common drawing FD and difference drawing FD are located such that the common drawing FD will be read prior to the difference drawing FD so as to enable the form registration job to be output prior to the overlay printing job.

In the present embodiment, in copying for second and its subsequent FDs illustrated in step S601, there is a possibility that one common drawing FD and one or more difference drawing FDs already exist at the time of step S601. Therefore, copying is performed before all of the difference drawing FDs and the original FD and after the common drawing FD.

After step S616 illustrated in FIG. 20 (in the state illustrated in FIG. 17), in step S1701, the OF 302 determines whether there is two common drawing FDs at present. When the OF 302 determines that there is one common drawing FD (NO in step S1701), the process is completed.

When the OF 302 determines that there are two common drawing FDs (YES in step S1701), flow proceeds to step S1702. In step S1702, the same drawing FP as the common drawing FP created for the currently processed FD is searched for.

In step S1703, the OF 302 determines whether the same drawing FP is found from the already existing common drawing FD. When the OF 302 determines that the same drawing FP is not found (NO in step S1703), flow proceeds to step S1704.

In step S1704, the OF 302 adds the common drawing FP created for the currently processed FD to the already existing common drawing FD. In step S617, the common drawing FD created for the currently processed FD is deleted, and the process is completed.

In step S1703, when the OF 302 determines that the same common drawing FP is found (YES in step S1703), flow proceeds to step S1705. In step S1705, the registration form name specified in the form registration PT added to that common drawing FP is acquired, and flow proceeds to step S617.

The registration form name created in step S615 or acquired in step S1705 is used as the used form name in the overlay printing PT to be added to the difference drawing FD in step S811 illustrated in FIG. 14.

In such a way, a common drawing FP and a difference drawing FP are created for each document created from a different template document, and form registration and overlay printing corresponding to them can be achieved.

The present embodiment also supports a case where original print data has only one FD and has a configuration that includes the processing of the first embodiment. Third Embodiment

After the process for changing a document structure in step S402 illustrated in FIG. 4 by the OF 302, if print data is saved in a file, it can be reused as XPS data. However, if XPS data is displayed using a standard viewer, a common drawing FD and a difference drawing FD illustrated in FIG. 10 are displayed in different pages.

To avoid this, in a printing system environment that includes an information processing apparatus having only a standard viewer, one approach to using such XPS data is to change the data structure of the XPS data in the following way. The embodiment thereof is described below.

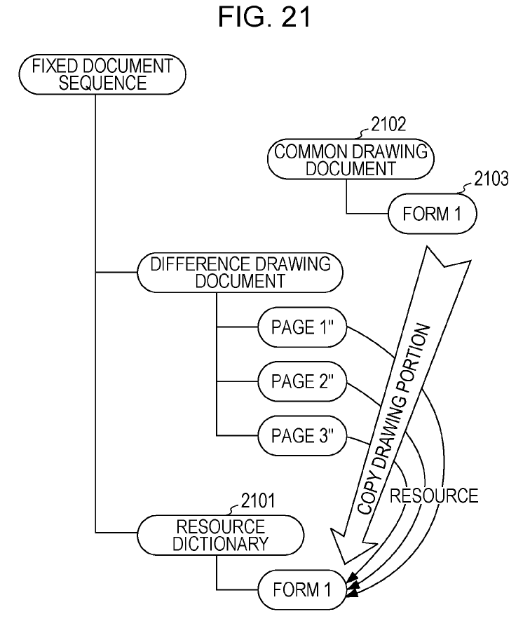

FIG. 21 illustrates an example data structure of print data being processed in the information processing apparatus according to the present embodiment.

As illustrated in FIG. 21, in the present embodiment, the OF 302 copies a common drawing portion to a resource dictionary 2101 and thereby places a drawing portion 2103 of the common drawing FP in the resource dictionary 2101. The OF 302 adds a referring object (Canvas) to the lowest level of the difference drawing FP to change the document structure such that a resource will be referred to.

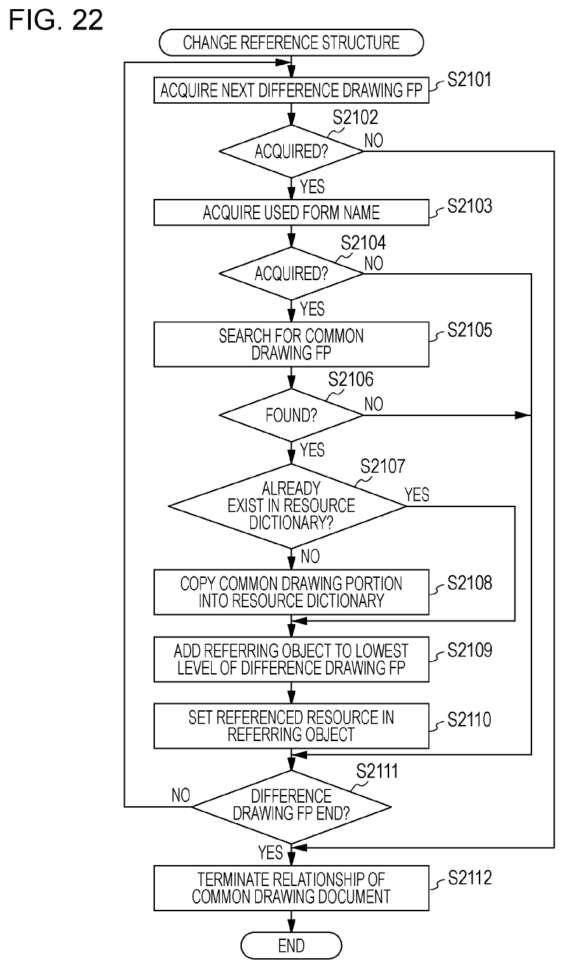

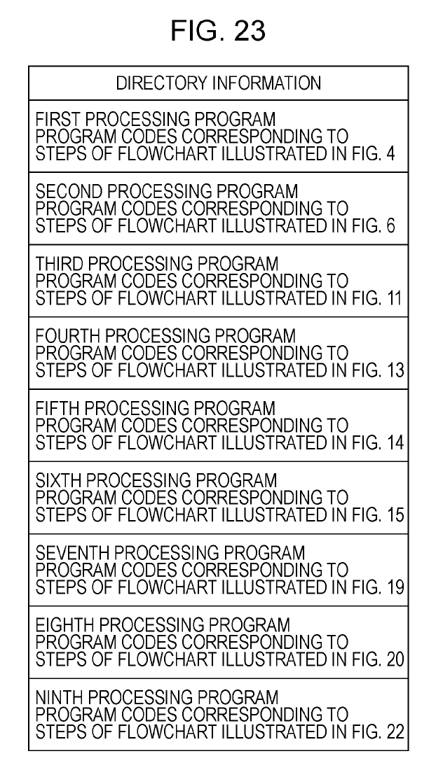

FIG. 22 is a flowchart that illustrates one example of a data processing process performed in the information processing apparatus according to the present embodiment. This example indicates an example detailed process for changing a reference structure. Steps S2101 to S2112 are achieved by the CPU 1 illustrated in FIG. 1 loading the OF 302 into the RAM 2 and executing it.

First, in step S2101, the OF 302 acquires the first difference drawing FP. Then, in step S2102, the OF 302 determines whether the first difference drawing FP is acquired. When the OF 302 determines that the first difference drawing FP is acquired (YES in step S2102), in step S2103, the OF 302 acquires the used form name of the overlay printing PT of that acquired FP. If the difference drawing FD includes an FP in which overlay printing is not to be performed, the name cannot be acquired.

Then, in step S2104, the OF 302 determines whether the used form name of the overlay printing PT of the FP is acquired. When the OF 302 determines that the used form name is acquired (YES in step S2104), in step S2105, an FP that has the same registration form name in the form registration PT as the acquired name is searched for in the common drawing FD.

In step S2106, the OF 302 determines whether an FP that has the same registration form name in the form registration PT as the acquired name (in the example illustrated in FIG. 21, the FP 2103) is found. When the OF 302 determines that the FP having the same registration form name in the form registration PT as the acquired name is found (YES in step S2106), flow proceeds to step S2107.

In step S2107, the OF 302 determines whether a resource having the same drawing as the drawing portion of that FP already exists under the resource dictionary 2101 by searching.

When the OF 302 determines that no resource having the same drawing as the drawing portion of that FP already exists under the resource dictionary 2101 (NO in step S2107), flow proceeds to step S2108.

In step S2108, the OF 302 copies the common drawing portion as a resource to the resource dictionary 2101. In step S2109, the OF 302 adds a referring Canvas object to the lowest level of the currently processed difference drawing FP.

In step S2110, the OF 302 sets the attribute of the difference drawing FP such that the added or found resource is a part to which the FP refers. After that, in step S2111, the OF 302 determines whether there exists a next difference drawing FP. When the OF 302 determines that a next difference drawing FP exists (NO in step S2111), flow returns to step S2101.

When it is determined that all of the difference drawing FPs are subjected to steps S2101 to S2110, that is, a next difference drawing FP does not exist (YES in step S2111), flow proceeds to step S2112.

In step S2112, the OF 302 deletes the common drawing FD from the relationship of a FDS, and the process is completed.

In the present embodiment, a common drawing FD 2102 remains in FIG. 21 in consideration of the possibility of returning it again. However, the common drawing FD itself may be deleted.

A configuration of a data processing program readable by an information processing apparatus according to at least one embodiment of the present invention is described below with reference to FIG. 23.

FIG. 23 illustrates an example memory map of a storage medium that stores various data processing programs readable by the information processing apparatus according to at least one embodiment of the present invention.

Although not illustrated in the drawing, information used for managing programs stored in a storage medium, for example, information on a version and an author, and information dependent on an OS at a program reading side, for example, information on an icon used for identifying a program may be stored.

Additionally, data dependent on various programs are also managed in the directory. In some cases, a program for use in installing various programs into a computer or, when a program to be installed is compressed, a program for use in extracting the compressed program may be stored.

The functions illustrated in FIGS. 7 and 10 in the present embodiment may also be carried out by a host computer using an externally installed program. In this case, the present invention is also applicable to a case where information sets including the program are supplied to an output device from a storage medium, for example, a compact-disk read-only memory (CD-ROM), a flash memory, or an FD, or an external storage medium over a network.

A storage medium that records program code for software achieving the functions of at least one of the above-described embodiments, as described above, may be supplied to a system or an apparatus, and the program code stored in the storage medium may be read and executed by a computer (or CPU or microprocessor unit (MPU)).

In this case, the program code itself read from the storage medium achieves new functions of the present invention. The storage medium storing the program code so as to allow the computer to read the program code is included in the present invention.

Accordingly, the program may have any form, such as object code, a program executed by an interpreter, or script data supplied to an OS, as long as the functions of the program are included.

Examples of a storage medium for supplying a program include an FD, a hard disk, an optical disk, a magneto-optical (MO) disk, a CD-ROM, a CD-recordable (CD-R), a CD-Rewritable (CD-RW), magnetic tape, a nonvolatile memory card, a ROM, a digital versatile disc (DVD).

In this case, the program code itself read from the storage medium achieves the functions of at least one of the above-described embodiments. The storage medium storing the program code is included in the present invention.

Another method for supplying a program is a method of causing a user to connect to a web site on the Internet using a browser at a client computer and to download, from the web site, a computer program of the present invention itself or a compressed file with an automatic install function into a storage medium (e.g., a hard disk). The program may also be supplied by causing the user to download, from different web sites, files into which program code constituting the program of the present invention is divided. That is, a WWW server and FTP server for allowing a plurality of users to download a program file for use in performing the functional processing on a computer are also included in the scope of the claims of the present invention.

The functions of at least one of the above-described embodiments can also be performed by storing an encrypted program of the present invention into storage media (e.g., CD-ROMs), distributing the storage media to users, causing a user who satisfies a predetermined condition to download key information for use in decoding from a web site over the Internet, causing the computer to execute and install the encrypted program using the key information.

The functions of at least one of the above-described embodiments are achieved by not only execution of program code read by a computer. For example, the functions of at least one of the above-described embodiments may be achieved by actual processing in part or in entirety performed by an OS running on the computer in response to instructions of the program code.

In addition, the functions of at least one of the above-described embodiments may be achieved by, after program code read from a storage medium is written in a memory included in a function expansion board inserted into a computer or a function expansion unit connected to a computer, actual processing in part or in entirety performed by a CPU included in the function expansion board or the function expansion unit in response to instructions of the program code.

The present invention is not limited to the above-described embodiments. Various modifications (including organic combinations of the embodiments) based on the principles of the present invention can be made, and they are intended to be embraced in the scope of the present invention.

Various examples and embodiments of the present invention are described above. It is evident for those skilled in the art that the spirit and scope of the present invention are not limited to a particular description in the specification.

In accordance with the embodiments of the present invention, a form registration job and an overlay printing job can be created for document information output form an application in response to a simple operation instruction.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2008-195241 filed Jul. 29, 2008, which is hereby incorporated by reference herein in its entirety.

What is claimed is:

1. An information processing apparatus for outputting, to a printing device, document information comprising a plurality of pages output from an application, the information processing apparatus comprising:
an instruction unit configured to provide an instruction to perform overlay printing using a form created from the document information;
a reconfiguration unit configured to, in response to the instruction to perform overlay printing provided by the instruction unit, compare objects contained in the document information and reconfigure the document information to a common drawing portion common to a plurality of pages and a difference drawing portion in which the common drawing portion common to the plurality of pages is removed from the document information; and
a job creation unit configured to create a form registration job based on the common drawing portion obtained by the reconfiguration unit and an overlay job based on the difference drawing portion obtained by the reconfiguration unit.

2. The information processing apparatus according to claim 1, wherein the reconfiguration unit is configured to reconfigure the document information such that the common drawing portion will be read prior to the difference drawing portion.

3. The information processing apparatus according to claim 1, wherein the document information has a document structure being a tree structure having a predetermined hierarchy.

4. The information processing apparatus according to claim 1, wherein the reconfiguration unit is configured to compare drawing objects of the plurality of pages of the document information sequentially from a lowest level and extract the common drawing portion.

5. The information processing apparatus according to claim 1, wherein the reconfiguration unit is configured to compare types of drawing objects and extract a drawing object of the common drawing portion or a drawing object of the difference drawing portion.

6. A job processing method for use in an information processing apparatus for outputting, to a printing device, document information comprising a plurality of pages output from an application, the job processing method comprising:
providing an instruction to perform overlay printing using a form created from the document information;
in response to the instruction to perform overlay printing provided in the providing, comparing objects contained in the document information and reconfiguring the document information to a common drawing portion common to a plurality of pages and a difference drawing portion in which the common drawing portion common to the plurality of pages is removed from the document information; and
creating a form registration job based on the common drawing portion obtained in the reconfiguring and an overlay job based on the difference drawing portion obtained in the reconfiguring.

7. The job processing method according to claim 6, wherein, in the reconfiguring, the document information is reconfigured such that the common drawing portion will be read prior to the difference drawing portion.

8. The job processing method according to claim 6, wherein the document information has a document structure being a tree structure having a predetermined hierarchy.

9. The job processing method according to claim 6, wherein, in the reconfiguring, drawing objects of the plurality of pages of the document information are compared sequentially from a lowest level and the common drawing portion is extracted.

10. The job processing method according to claim 6, wherein, in the reconfiguring, types of drawing objects are compared and a drawing object of the common drawing portion or a drawing object of the difference drawing portion is extracted.

11. A storage medium storing a program executable by a computer that outputs, to a printing device, document information comprising a plurality of pages output from an application, the program causing the computer to execute:
providing an instruction to perform overlay printing using a form created from the document information;
in response to the instruction to perform overlay printing provided in the providing, comparing objects contained in the document information and reconfiguring the document information to a common drawing portion common to a plurality of pages and a difference drawing portion in which the common drawing portion common to the plurality of pages is removed from the document information; and
creating a form registration job based on the common drawing portion obtained in the reconfiguring and an overlay job based on the difference drawing portion obtained in the reconfiguring.

12. The storage medium according to claim 11, wherein, in the reconfiguring, the document information is reconfigured such that the common drawing portion will be read prior to the difference drawing portion.

13. The storage medium according to claim 11, wherein the document information has a document structure being a tree structure having a predetermined hierarchy.

14. The storage medium according to claim 11, wherein, in the reconfiguring, drawing objects of the plurality of pages of the document information are compared sequentially from a lowest level and the common drawing portion is extracted.

15. The storage medium according to claim 11, wherein, in the reconfiguring, types of drawing objects are compared and a drawing object of the common drawing portion or a drawing object of the difference drawing portion is extracted.
